(19) United States
(12) Patent Application Publication
(10) Pub. No.: US 2024/0311507 A1
(43) Pub. Date: Sep. 19, 2024

(54) ELECTRONIC DEVICE, AND OUTPUT DATA DETERMINATION METHOD OF EXTERNAL DEVICE

(71) Applicant: Samsung Electronics Co., Ltd., Suwon-si (KR)

(72) Inventors: Youngwook NAM, Suwon-si (KR); Eunhye KIM, Suwon-si (KR); Hyori PARK, Suwon-si (KR); Suyeon JUNG, Suwon-si (KR)

(21) Appl. No.: 18/675,728

(22) Filed: May 28, 2024

Related U.S. Application Data
(63) Continuation of application No. PCT/KR2022/019163, filed on Nov. 30, 2022.

(30) Foreign Application Priority Data
Dec. 14, 2021 (KR) 10-2021-0178972
Jan. 18, 2022 (KR) 10-2022-0007366

(51) Int. Cl. G06F 21/62; G06F 3/01; G06F 3/04845

(52) U.S. Cl. CPC G06F 21/6245; G06F 3/011; G06F 3/04845

(57) ABSTRACT

An electronic device is provided. The electronic device includes a microphone, a camera, communication circuitry, memory storing one or more computer programs, and one or more processors communicatively coupled to the microphone, the camera, the communication circuitry, and the memory, wherein the one or more computer programs include computer-executable instructions that, when executed by the one or more processors, cause the electronic device to receive input data from the microphone, the camera and/or at least one wearable device, modify at least some of the input data or determine at least some of input data as data that are not to be transmitted from an external server to an external device based on whether at least some of the input data satisfy a designated condition, and transmit the input data to the external server.

### CROSS-REFERENCE TO RELATED APPLICATION(S)

This application is a continuation application, claiming priority under § 365(c), of an International application No. PCT/KR2022/019163, filed on Nov. 30, 2022, which is based on and claims the benefit of a Korean patent application number 10-2021-0178972, filed on Dec. 14, 2021, in the Korean Intellectual Property Office, and of a Korean patent application number 10-2022-0007366, filed on Jan. 18, 2022, in the Korean Intellectual Property Office, the disclosure of each of which is incorporated by reference herein in its entirety.

### BACKGROUND

### 1. Field

The disclosure relates to an electronic device. More particularly, the disclosure relates to a method of determining data outputted from an external device on the basis of input data of the electronic device.

### 2. Description of Related Art

With the development of mobile communication technologies and hardware/software technologies, portable electronic devices (hereinafter, referred to as ‘electronic devices’) have been able to implement a variety of functions beyond traditional calling functions. The electronic devices may establish communication connection with various external devices and transmit and receive data. For example, the electronic device may use near field communication to transmit and receive data to and from a wearable device worn on a user's body, and the electronic device may establish communication connection with an external server and transmit and receive data. Multiple users may share data by using the electronic devices, and there may be a need to protect the user's privacy.

For example, a plurality of users may work out together while sharing their workouts with each other via the electronic devices. In this case, the electronic device of each user may collect data related to each user's workout by using a sensor and output a user interface, which includes information on workout states of other users, on a display while operating in conjunction with the external server.

The above information is presented as background information only to assist with an understanding of the disclosure. No determination has been made, and no assertion is made, as to whether any of the above might be applicable as prior art with regard to the disclosure.

### SUMMARY

An electronic device in the related art has no separate means capable of protecting users' data when the users share data with external users, which causes a problem in that data that the user does not want to make available to the public are exposed to the public. For example, image data is continuously transmitted even though the user falls during the workout or the user pauses the workout for a moment and does other activities. If the image data that the user does not want to make available to the public is exposed to the public, which causes an issue with privacy protection.

Aspects of the disclosure are to address at least the above-mentioned problems and/or disadvantages and to provide at least the advantages described below. Accordingly, an aspect of the disclosure is to provide a method of modifying some data, which are transmitted from an electronic device on the basis of input data as described above, or determining data to be displayed on an external device.

Additional aspects will be set forth in part in the description which follows and, in part, will be apparent from the description, or may be learned by practice of the presented embodiments.

In accordance with an aspect of the disclosure, an electronic device is provided. The electronic device includes a microphone, a camera, a communication circuitry, memory storing one or more computer programs, and one or more processors communicatively coupled to the microphone, the camera, the communication circuitry, and the memory, wherein the one or more computer programs include computer-executable instructions that, when executed by the one or more processors, cause the electronic device to receive input data from the microphone, the camera, and/or at least one wearable device, modify at least some of the input data or determine at least some of the input data as data that are not to be transmitted from the external server to the external device based on whether at least some of the input data satisfy a designated condition, and transmit the input data to the external server.

In accordance with another aspect of the disclosure, an output data determination method of an external device is provided. The method includes establishing communication connection between at least one wearable device and an external server by using a communication circuitry, receiving input data from a microphone, a camera, or the at least one wearable device, modifying at least some of the input data or determining at least some of the input data as data, that are not to be transmitted from the external server to the external device, based on whether at least some of the input data satisfies a designated condition, and transmitting the input data to the external server.

According to various embodiments of the disclosure, the electronic device determines the data, which are not to be displayed on the external device among the user's input data, based on the input data received from the wearable device, the camera, and the microphone. The electronic device prevents the image, the voice, and/or the data that the user does not want to expose to other users from being outputted from the external device, thereby more effectively protecting the user's privacy.

In an accordance with another aspect of the disclosure, one or more non-transitory computer readable recording media storing computer-executable instructions that, when executed by one or more processors of an external device, cause the external device to perform operations are provided. The operations include establishing communication connection between at least one wearable device and an external server by using a communication circuitry, receiving input data from a microphone, a camera, or the at least one wearable device, modifying at least some of the input data or determining at least some of the input data as data that are not to be transmitted from the external server to the external device based on whether at least some of the input data satisfies a designated condition, and transmitting the input data to the external server.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 is a configuration view of a network environment connected to an electronic device according to an embodiment of the disclosure;

FIG. 3 is a block diagram of an electronic device according to an embodiment of the disclosure;

FIG. 4 is a view illustrating a user interface outputted by an electronic device according to an embodiment of the disclosure;

FIG. 5 is a view illustrating a state in which an electronic device provides a notification to a user when input data satisfy a designated condition according to an embodiment of the disclosure;

FIG. 6 is a view illustrating an embodiment in which an electronic device modifies image data according to an embodiment of the disclosure;

FIG. 7 is a view illustrating an embodiment in which an electronic device modifies image data and voice data according to an embodiment of the disclosure;

FIG. 8 is a view illustrating an embodiment in which an electronic device modifies image data and voice data according to an embodiment of the disclosure; and

FIG. 9 is a flowchart of an output data determination method of an electronic device according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

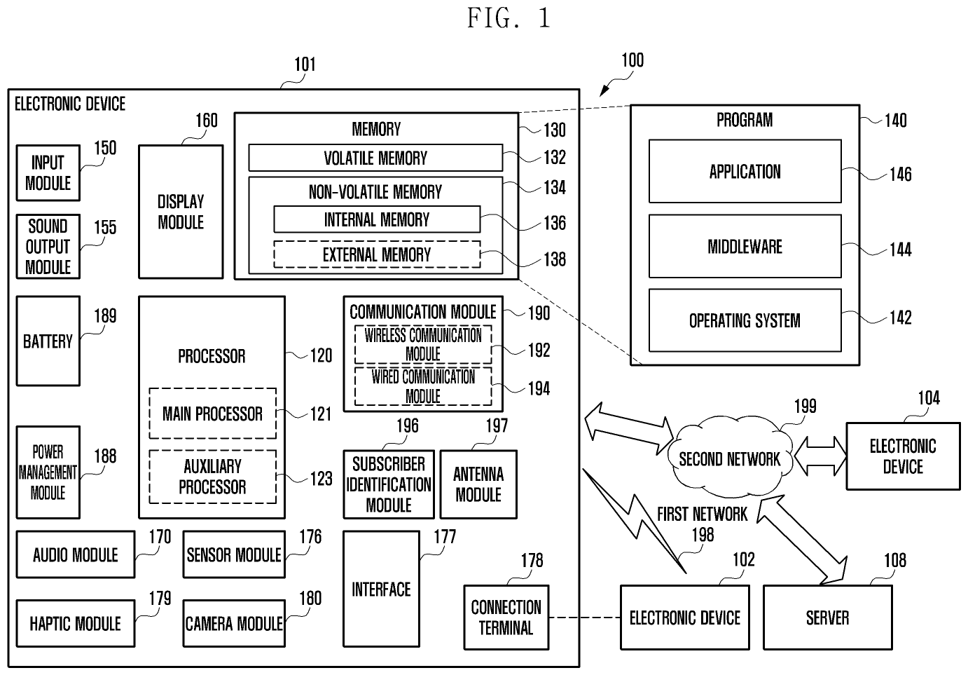

FIG. 1 is a block diagram illustrating an electronic device in a network environment according to an embodiment of the disclosure.

Referring to FIG. 1, an electronic device 101 in a network environment 100 may communicate with an external electronic device 102 via a first network 198 (e.g., a short-range wireless communication network), or at least one of an external electronic device 104 or a server 108 via a second network 199 (e.g., a long-range wireless communication network). According to an embodiment of the disclosure, the electronic device 101 may communicate with the external electronic device 104 via the server 108. According to an embodiment of the disclosure, the electronic device 101 may include a processor 120, memory 130, an input module 150, a sound output module 155, a display module 160, an audio module 170, a sensor module 176, an interface 177, a connection terminal 178, a haptic module 179, a camera module 180, a power management module 188, a battery 189, a communication module 190, a subscriber identification module (SIM) 196, or an antenna module 197. In some embodiments of the disclosure, at least one of the components (e.g., the connection terminal 178) may be omitted from the electronic device 101, or one or more other components may be added in the electronic device 101. In some embodiments of the disclosure, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment of the disclosure, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment of the disclosure, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., a sleep) state, or together with the main processor 121 while the main processor 121 is in an active state (e.g., executing an application). According to an embodiment of the disclosure, the auxiliary processor 123 (e.g., an image signal processor or a communication processor) may be implemented as part of another component (e.g., the camera module 180 or the communication module 190) functionally related to the auxiliary processor 123. According to an embodiment of the disclosure, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134. The non-volatile memory may include at least one of internal memory 136 and external memory 138.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment of the disclosure, the display module 160 may include a touch sensor adapted to detect a touch, or a pressure sensor adapted to measure the intensity of force incurred by the touch.

The audio module 170 may convert a sound into an electrical signal and vice versa. According to an embodiment of the disclosure, the audio module 170 may obtain the sound via the input module 150, or output the sound via the sound output module 155 or a headphone of an external electronic device (e.g., the external electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. According to an embodiment of the disclosure, the interface 177 may include, for example, a high definition multimedia interface (HDMI), a universal serial bus (USB) interface, a secure digital (SD) card interface, or an audio interface.

The connection terminal 178 may include a connector via which the electronic device 101 may be physically connected with the external electronic device (e.g., the external electronic device 102). According to an embodiment of the disclosure, the connection terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment of the disclosure, the haptic module 179 may include, for example, a motor, a piezoelectric element, or an electric stimulator.

The camera module 180 may capture a still image or moving images. According to an embodiment of the disclosure, the camera module 180 may include one or more lenses, image sensors, image signal processors, or flashes.

The power management module 188 may manage power supplied to the electronic device 101. According to one embodiment of the disclosure, the power management module 188 may be implemented as at least part of, for example, a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the external electronic device 104), or a network system (e.g., the second network 199). According to an embodiment of the disclosure, the wireless communication module 192 may support a peak data rate (e.g., 20 gigabits per second (Gbps) or more) for implementing eMBB, loss coverage (e.g., 164 decibels (dB) or less) for implementing mMTC, or U-plane latency (e.g., 0.5 milliseconds (ms) or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment of the disclosure, the antenna module 197 may include an antenna including a radiating element including a conductive material or a conductive pattern formed in or on a substrate (e.g., a printed circuit board (PCB)). According to an embodiment of the disclosure, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment of the disclosure, another component (e.g., a radio frequency integrated circuit (RFIC)) other than the radiating element may be additionally formed as part of the antenna module 197.

According to various embodiments of the disclosure, the antenna module 197 may form an mmWave antenna module. According to an embodiment of the disclosure, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment of the disclosure, all or some of operations to be executed at the electronic device 101 may be executed at one or more of the external electronic devices (e.g. the external electronic devices 102 and 104 or the server 108). For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment of the disclosure, the external electronic device 104 may include an Internet-of-things (IoT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it denotes that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment of the disclosure, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each component (e.g., a module or a program) of the above-described components may include a single entity or multiple entities, and some of the multiple entities may be separately disposed in different components. According to various embodiments of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added.

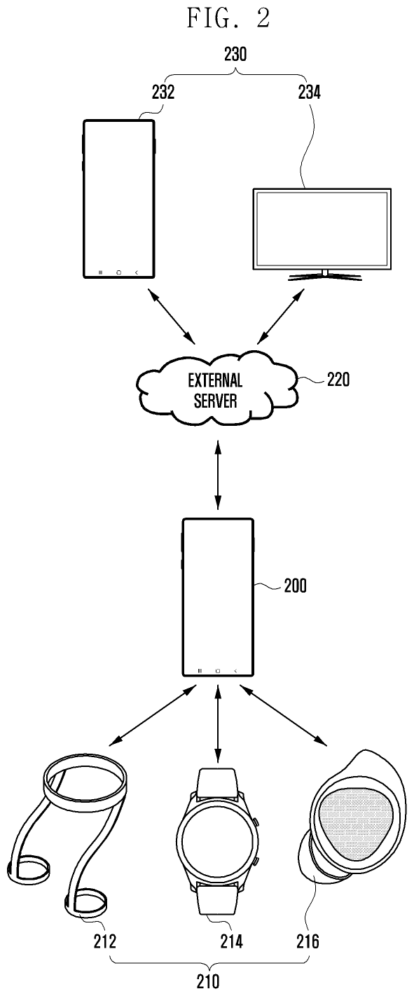

FIG. 2 is a configuration view of a network environment connected to an electronic device according to an embodiment of the disclosure.

Referring to FIG. 2, an electronic device 200 may be communicatively connected to various wearable devices 210 and an external server 220, and the external server 220 may be communicatively connected to an external device 230. The wearable devices may include at least one of a wearable robot 212, a smart watch 214, and an ear piece 216. For example, the wearable robot 212 may be mounted on a user's leg and acquire data, such as the user's muscular strength, areas with concentrated muscular strength, side-to-side balance, stride lengths, walking strength, calorie consumption, workout times, workout distances, workout speeds, and step counts. For example, the smart watch 214 may be mounted on the user's wrist and acquire data, such as workout time, workout distances, workout speeds, step counts, heart rates, recovery heart rates, calorie consumption, maximum oxygen uptake, average running paces, peak running paces, side-to-side balance, vertical amplitude, sweat output amount, and workout load information. For example, the ear piece 216 may be mounted on the user's ear and acquire voice data around the ear piece 216. The electronic device 200 may establish communication connection with various wearable devices 210 and acquire data from the wearable devices 210. The electronic device 200 may acquire voice data and/or image data around the electronic device 200 by using a microphone and a camera included in the electronic device 200. Hereinafter, the input data may refer to data, which are acquired by the electronic device 200 from the wearable devices 210 through the communication connection, and data acquired by using at least one of the microphone and the camera.

According to various embodiments of the disclosure, the electronic device 200 may establish the communication connection with the external server 220. The electronic device 200 may transmit data to the external device 230 by using the communication connection with the external server 220, and on the contrary, the electronic device 200 may receive data transmitted from the external device 230. For example, the electronic device 200 may transmit the input data to the external server 220 so that the input data may be displayed on the external device 230. On the contrary, the electronic device 200 may receive data of the external device 230 from the external server 220 and output the data to a display of the electronic device 200. According to the embodiment of the disclosure, the electronic device 200 may determine data that are not to be displayed on the external device 230 among the data to be transmitted to the external server 220. For example, the electronic device 200 may determine image data as the data that are not to be displayed on the external device 230, and the electronic device 200 may transmit the determined data to the external server 220. When the image data are determined by the electronic device 200 as the data that are not to be displayed on the external device 230, the external server 220 may receive the image data but may not transmit the image data to the external device 230.

According to various embodiments of the disclosure, the external server 220 may transmit the input data to the external device 230. The external device 230 may be the electronic device 200 including an image display part. For example, the external device 230 may include at least one of a terminal 232 and a TV 234. The external server 220 may receive the input data from the electronic device 200 and transmit, to the external device 230, the remaining data excluding the data determined as the data that are not to be displayed on the external device 230. For example, the external server 220 may receive heart rate data, voice data, and image data from the electronic device 200, but the voice data and the image data may be determined not to be transmitted to the external device 230. The external server 220 may transmit only the heart rate data to the external device 230 without transmitting the voice data and the image data. The external device 230 may output the data, which are received from the external server 220, through a display and a speaker of the external device 230.

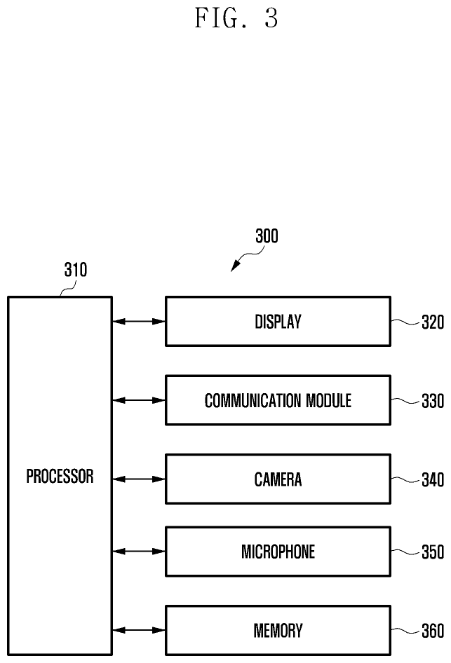

FIG. 3 is a block diagram of an electronic device according to an embodiment of the disclosure.

Referring to FIG. 3, an electronic device 300 (e.g., the electronic device 200 in FIG. 2) may include a display 320, a communication module 330, a camera 340, a microphone 350, a processor 310, and memory 360. In various embodiments of the disclosure, some of the illustrated components may be excluded or replaced. The electronic device 300 may further include at least some of the configurations and/or functions of the electronic device 101 in FIG. 1. At least some of the illustrated (or non-illustrated) components of the electronic device 300 may be operatively, functionally, and/or electrically connected to one another.

According to various embodiments of the disclosure, the display 320 may display various images under the control of the processor 310. The display 320 may be implemented as any one of a liquid crystal display (LCD), a light-emitting diode (LED) display, a micro-LED display, a quantum-dot (QD) display, and an organic light-emitting diode (OLED) display. However, the disclosure is not limited thereto. The display 320 may be configured as a touch screen that detects a touch and/or proximity touch (or hovering) input made by using a part of the user's body (e.g., a finger) or an input device (e.g., a stylus pen). The display 320 may include at least some of the configurations and/or functions of the display module 160 in FIG. 1.

According to various embodiments of the disclosure, at least a part of the display 320 may be flexible and implemented as a foldable display or a rollable display.

According to various embodiments of the disclosure, the communication module 330 may communicate with the external device (e.g., the external device 230 in FIG. 2) through a wireless network under the control of the processor 310. The communication module 330 may include hardware modules and software modules configured to transmit and receive data to and from a cellular network (e.g., a long-term evolution (LTE) network or a 5G network) and a short-range network (e.g., Wi-Fi or Bluetooth™). The communication module 330 may include at least some of the configurations and/or functions of the communication module 190 of FIG. 1.

According to various embodiments of the disclosure, the camera 340 may acquire external image data. The camera 340 may acquire the image data by using various types of image sensors, such as a charge-coupled device (CCD) or a complementary metal oxide semiconductor (CMOS). The camera 340 may include at least some of the configurations and/or functions of the camera module 180 in FIG. 1. The electronic device 300 may have the camera 340 disposed on a front surface and/or a rear surface of a housing.

According to various embodiments of the disclosure, the microphone 350 may collect external sounds, such as the user's voice and convert the external sounds into voice signals that are digital data. According to various embodiments of the disclosure, the electronic device 300 may include the microphone 350 included in a part of the housing (not illustrated) or receive a voice signal collected by an external microphone connected in a wired/wireless manner.

According to various embodiments of the disclosure, the memory 360 may include volatile memory (e.g., the volatile memory 132 in FIG. 1) and non-volatile memory (e.g., the non-volatile memory 134 in FIG. 1) and temporarily or permanently store various data. The memory 360 may include at least some of the configurations and/or functions of the memory 130 in FIG. 1 and store the program 140 in FIG. 1.

According to various embodiments of the disclosure, the memory 360 may store various instructions capable of being executed by the processor 310. The above-mentioned instructions may include control instructions, such as arithmetic and logical operations, data movements, input/output, and the like that may be recognized by the processor 310.

According to various embodiments of the disclosure, the processor 310 may be operatively, functionally, and/or electrically connected to the components of the electronic device 300 (e.g., the display 320, the communication module 330, the camera 340, the microphone 350, and the memory 360) and configured to control the components, perform computation related to communication, and/or process data. The processor 310 may include at least some of the configurations and/or functions of the processor 120 in FIG. 1.

According to various embodiments of the disclosure, the processor 310 is not limited to computation and data processing functions that may be implemented in the electronic device 300. However, hereinafter, various embodiments will be described in which the processor 310 determines data that are to be displayed on the external device on the basis of the input data. The operations of the processor 310, which will be described below, may be performed by loading the instructions stored in the memory 360.

A method of determining, by the processor 310, data to be displayed on the external device will be described below briefly. The processor 310 may control the communication module 330 to establish the communication connection between the wearable device (e.g., the wearable devices 210 in FIG. 2) and the external server (e.g., the external server 220 in FIG. 2). The processor 310 may acquire the input data by using the wearable device, the camera 340, and the microphone 350 and create computation data on the basis of the input data. On the basis of at least one of the input data and the computation data, the processor 310 may modify some of the data to be displayed on the external device or determine at least some of the data that are not to be displayed. The processor 310 may determine whether to modify the data and whether to display at least some of the data on the external device and then transfer information, which indicates whether to display the input data and data, to the external server. Hereinafter, an operation of the disclosure will be described below.

According to various embodiments of the disclosure, the processor 310 may control the communication module 330 to establish the communication connection between the wearable device and the external server. The processor 310 may establish the communication connection with at least one wearable device. For example, the processor 310 may establish the communication connection with the wearable device, such as a wearable robot, a smart watch, and an ear piece.

According to various embodiments of the disclosure, the processor 310 may acquire the input data. The input data may be data acquired from the wearable device communicatively connected to the processor 310 or data acquired directly by the processor 310 by using the microphone 350 and the camera 340. For example, the processor 310 may establish the communication connection with the smart watch and receive data, such as workout speeds, average heart rates during workout, average heart rates at ordinary times, sweat output, drops, calorie consumption, average pace, highest pace, workout load information, stress indexes detected by the smart watch. For example, the processor 310 may establish the communication connection with the wearable robot and acquire data, such as muscular strength, areas with concentrated muscular strength, calorie consumption, muscle activities, body balance, stride lengths, and walking strength. For example, the processor 310 may establish the communication connection with the ear piece and acquire voice data.

According to various embodiments of the disclosure, the processor 310 may directly collect the input data without using the wearable device communicatively connected to the processor 310. According to the embodiment of the disclosure, the processor 310 may acquire the voice data by using the microphone 350. For example, the processor 310 may acquire the voice data around the electronic device 300 by activating the microphone 350. According to another embodiment of the disclosure, the processor 310 may acquire the image data by using the camera 340. For example, the image data may be acquired by the camera 340 may mean an image indicating that the user performs a workout or activity.

According to various embodiments of the disclosure, the processor 310 may create computation data on the basis of the input data. For example, the computation data may include data, such as posture accuracy and workout performance points created on the basis of the input data, such as body balance, areas with concentrated muscular strength, image data, workout times, and workout distances, and rankings calculated on the basis of the input data and other data from the user. According to the embodiment of the disclosure, the processor 310 may receive at least some of the computation data from the external server. For example, the external server may receive data from the electronic device and at least one of the external devices, determine a ranking for each user on the basis of the calculated posture accuracy, and the ranking to the electronic device. The processor 310 may acquire ranking data from the external server.

According to various embodiments of the disclosure, the processor 310 may determine data, which are to be displayed on the external device, on the basis of the input data and/or the computation data. According to the embodiment of the disclosure, when the input data and/or computation data satisfy designated condition, the processor 310 may determine not to display the input data and/or computation data on the external device. For example, when the input data are larger than designated values, the processor 310 may determine no to display the input data on the external device. Hereinafter, a privacy situation may mean a situation in which on the basis of at least some of the input data and/or computation data, the processor 310 determines data that are to be or not to be displayed on the external device or determines to modify at least some of the data. For example, the privacy situation may include a data privacy situation, a voice privacy situation, and an image privacy situation. The data privacy situation may be a situation in which at least some of the data of the electronic device 300, which are to be displayed on the external device, are determined not to be displayed. The voice privacy situation may be a situation in which the voice data acquired by the processor 310 are determined not to be outputted from the external device. The image privacy situation may be a situation in which the image data acquired by the processor 310 are determined not to be outputted from the external device or a situation in which at least one region of the image data is determined to be modified and outputted from the external device. The processor 310 may determine whether the situation corresponds to at least one of the data privacy situation, the voice privacy situation, and the image privacy situation on the basis of the input data and the computation data, and the processor 310 may modify the data or determine not to display the data on the external device. For the purpose of explanation, the privacy situation is divided into the data privacy situation, the voice privacy situation, and the image privacy situation. The embodiment of the disclosure is not limited thereto. The method of processing various data for protecting user's privacy may be included. Hereinafter, an embodiment will be specifically described in which whether this situation is the privacy situation is determined on the basis of the data acquired by the processor 310, and the data are determined to be modified or determined not to be displayed on the external device.

According to various embodiments of the disclosure, the processor 310 may determine at least some of the input data and the computation data, which need not be exposed to the public, as the data privacy situation. According to the embodiment of the disclosure, the processor 310 may determine at least some of the data as protection data. The protection data may be the user's individual information and means information that is not displayed to the external user in the data privacy situation. For example, in case that the heart rate is 0, the heart rate is increased to a value equal to or larger than (e.g., 70% or more of) a designated value of an average heart rate at ordinary times, or the heart rate is increased to a value equal to or larger than (e.g., 30% or more of) a designated value of an average workout heart rate, the processor 310 may determine this situation as the data privacy situation In case that the data privacy situation is determined on the basis of the heart rate data, the processor 310 may determine the heart rate data as the protection data.

According to various embodiments of the disclosure, in case that the data privacy situation is determined, the processor 310 may determine not to display the protection data on the external device. For example, in case that the heart rate and the calorie consumption are determined as the protection data, the processor 310 may determine not to display the heart rate and the calorie consumption on the external device and transfer information, which indicates that the heart rate, the calorie consumption data and the heart rate, or the calorie consumption data need not be displayed, to the external server. According to the embodiment of the disclosure, the external server may not transmit the data, which are determined as the protection data, to the external device. According to another embodiment of the disclosure, the external server may transmit the data, which are determined as the protection data, to the external device but instruct the external device not to display the protection data.

According to various embodiments of the disclosure, in case that the processor 310 detects an inappropriate word or receives a sound at a decibel level above a predetermined value, the processor 310 may determine this situation as the voice privacy situation. The processor 310 may learn the user's voice in advance. In case that a voice, which is not the user's voice in the received voice data, is recognized, the processor 310 may determine not to output the voice data from the external device. For example, in case that a family member walks into the room and talks to the user while the user works out while looking at the electronic device 300, the processor 310 may detect a voice that does not belong to the user and determine that this situation is the voice privacy situation.

According to various embodiments of the disclosure, when the voice privacy situation is determined, the processor 310 may determine not to output (or determine to mute) the received voice data from the external device. The external device may not output the voice data received from the electronic device 300. After the voice privacy situation is ended, the external device may normally output the voice data again. For example, the processor may determine that the voice privacy situation is ended in response to a situation in which at least some items of the input data become smaller than predetermined values. The processor may not transfer information, which instructs the external device not to output the voice data, to the external server in response to the situation in which the voice privacy situation is determined to be ended. Because the external server does not receive the information, which instructs the external device not to output the voice data, any further, the voice data may be transmitted to the external device, and the external device may output the received voice data.

According to various embodiments of the disclosure, in case that the user disappears from a screen of the external device or falls, the processor 310 may determine this situation as the image privacy situation. In case that a result of analyzing the image data indicates that the corresponding image needs to be prevented from being outputted from the external device, the processor 310 may determine this situation as the image privacy situation. For example, in case that the user trips or falls while working out while watching images played on the electronic device 300, the processor 310 may detect that the user has fallen from the image data and determine this situation as the image privacy situation. In another example, in case that the user moves out of the screen and disappears from the screen or another person other than the user is recognized on the screen, the processor 310 may determine this situation as the image privacy situation.

According to various embodiments of the disclosure, when the image privacy situation is determined, the processor 310 may modify at least one region of the image data. The processor 310 may modify the image data by outputting a graphic object (e.g., an AR emoji) in at least one region of the image data. For example, in case that the image data include a scene in which the user falls, the processor 310 may output a graphic object in a region in which the user is outputted and create an image in which the scene in which the user falls is covered by the graphic object. The processor 310 may transmit the image data, to which the graphic object is added, to the external server so that another user cannot recognize, from the external device, the scene in which the user falls. According to another embodiment of the disclosure, the processor 310 may determine not to output the image data from the external device. For example, in case that the region in which the graphic object needs to be outputted from the image data has a designated value or more, the processor 310 may not output the graphic object and determine not to output the image data from the external device.

According to various embodiments of the disclosure, the processor 310 may determine that two or more types of privacy situations have occurred simultaneously. For example, the processor 310 may determine that the image privacy situation and the voice privacy situation have occurred simultaneously. For example, in case that the user stops working out to take a phone call during the workout, the processor may determine this situation as the image privacy situation and modify the image data so that the image, which indicates that the user talks on the phone, is not outputted from the external device. Further, the processor may determine this situation as the voice privacy situation and determine not to output the voice data from the external device to prevent the content of the phone call from being outputted from the external device. The embodiments in which the processor 310 determines the situations as the plurality of privacy situations are not limited thereto. The plurality of privacy situations may be determined on the basis of the input data and the computation data.

According to the embodiment of the disclosure, in case that a plurality of items in the input data satisfies the designated condition, the processor 310 may determine this situation as the privacy situation. For example, in case that another person's body other than the user's body is recognized from the image data and the muscle activation decreases by 30% or more for 3 second, this situation may be determined as the privacy situation. According to the embodiment of the disclosure, in case that the amount of change in body height is 50% or more for 3 second and the workout speed decreases by 80% or more for 3 seconds, this situation may be determined as the privacy situation.

According to various embodiments of the disclosure, the processor 310 may transmit the input data or computation data to the external server. The processor 310 may establish communication connection with the external server and transmit the input data. For example, the data transmitted by the processor 310 may include voice data and image data, and at least some of the transmitted data may be determined not to be outputted from the external device. For example, in the data privacy situation, the protection data may be determined not to be outputted to the external device. In the voice privacy situation, the voice data may be determined not to be outputted to the external device. In the image privacy situation, at least one region of the image data may be modified, or the image data may be determined not to be outputted.

According to various embodiments of the disclosure, the processor 310 may output a user interface, which is configured on the basis of the acquired input data and the acquired computation data, to the display 320. For example, the user interface of the processor 310 may include input data, computation data, and image data. The user interface may display the user's data of at least one external device. For example, the user interface may include a first user's image data and input data, a second user's image data and input data, and a third user's image data and input data. According to the embodiment of the disclosure, the user interface may further include a graphic object that instructs the external device to output the user's voice data. For example, in case that the second user is in the voice privacy situation, an icon, which indicates the voice is muted and not outputted, may be additionally displayed in a region in which the second user's data are outputted.

According to the embodiment of the disclosure, the processor 310 may output various comparison data on the basis of the data of the user of the electronic device 300 and the user of the external device. For example, in case that the users work out while watching workout images, the processor 310 may calculate rankings on the basis of workout performance and output the rankings to the display 320. The processor 310 may calculate the workout performance on the basis of the input data of the user of the electronic device 300 and the user of the external device and determine the rankings of the calculated workout performance of the plurality of users. The processor 310 may display the determined rankings in the region in which the user's data are displayed.

According to the embodiment of the disclosure, even in the privacy situation, the processor 310 of the electronic device 300 may output all the input data, the computation data, the image data, and the voice data. For example, in the image privacy situation, the processor 310 may determine to modify at least one region of the image data of the external device or determine not to output the image data from the external device. However, the electronic device 300 may output the image data in its original form. For example, in the data privacy situation, the processor 310 may determine not to output the protection data from the external device, but the electronic device 300 may output the protection data to the display 320.

According to various embodiments of the disclosure, the processor 310 may detect a situation in which the privacy situation is highly likely to occur, and the processor 310 may provide a notification to the user. A preliminary privacy situation may mean a situation that does not satisfy a criterion for the occurrence of the privacy situation but is relatively highly likely to occur. According to the embodiment of the disclosure, the criterion for which the processor 310 determines whether this situation is the preliminary privacy situation may have a value smaller than a reference value by which the processor 310 determines this situation as the privacy situation. For example, the processor 310 may determine a situation, in which the user's heart rate is increased by 70% in comparison with the average heart rate at ordinary times, as the privacy situation, and the processor 310 may determine a situation, in which the heart rate is increased by 50% in comparison with the average heart rate at ordinary times, as the preliminary privacy situation.

According to various embodiments of the disclosure, the processor 310 may modify at least some of the image data in the preliminary privacy situation. Because the privacy situation is highly likely to occur in the preliminary privacy situation, the processor 310 may modify at least some of the image data from the preliminary privacy situation in order to quickly cope with the privacy situation. For example, in case that the current user's workout speed satisfies a preliminary privacy reference value, the processor 310 may modify at least one region of the image data so that at least one region of the image data is semi-transparent. When the user's workout speed is high, the user may fall, and the privacy situation may occur. Therefore, the processor 310 may modify at least some of the image data from the preliminary privacy situation in order to quickly respond to the privacy situation. According to another embodiment of the disclosure, in a voice preliminary privacy situation, the processor 310 may reduce a volume of the voice data outputted from the external device. In a voice privacy situation, the processor 310 determines not to output the voice data from the external device. However, in the preliminary privacy situation, the processor 310 may determine to quickly respond to the occurrence of the privacy situation by reducing the volume of the voice data outputted from the external device.

According to various embodiments of the disclosure, the processor 310 may provide a notification to the user in the preliminary privacy situation. According to the embodiment of the disclosure, the processor 310 may provide the user with a notification related to a data item that reaches a preliminary privacy situation determination reference value. For example, in case that the user's workout speed satisfies the preliminary privacy situation determination reference value, the processor 310 may display a portion, which indicates the workout speed item, in a color different from the colors of the other portions on the user interface. For example, the notification may be provided to the user in a state in which the other data are displayed in a first color, and only the workout speed is displayed in a second color. According to another embodiment of the disclosure, the processor 310 may provide a voice guide that notifies the user of the preliminary privacy situation. For example, in case that the user's workout speed is too high, the processor may provide a voice guide, which instructs the user to reduce the workout speed, thereby preventing the occurrence of the privacy situation.

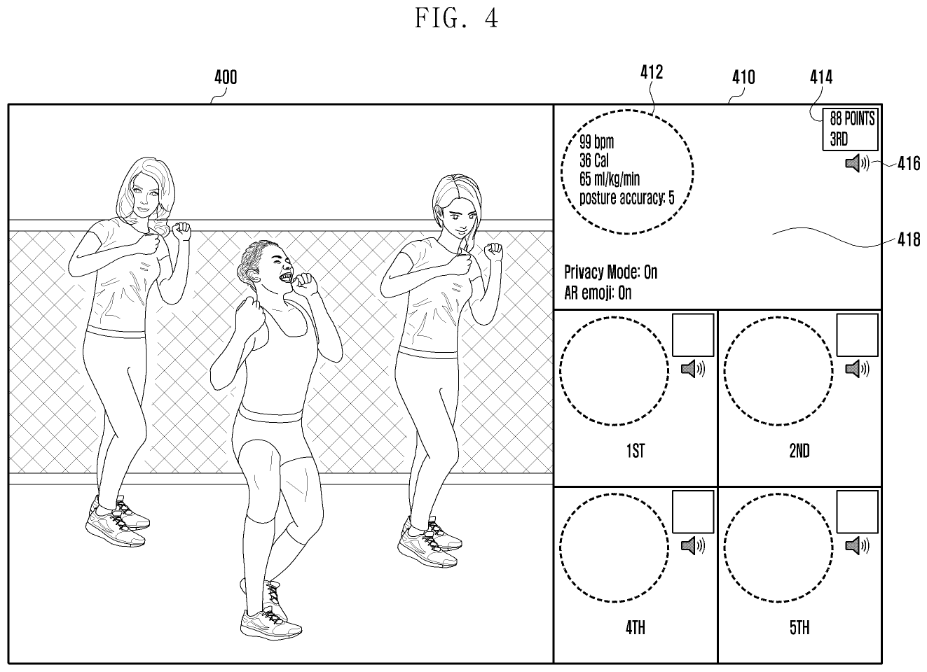

FIG. 4 is a view illustrating a user interface outputted by an electronic device according to an embodiment of the disclosure.

The method of determining, by the processor (e.g., the processor 310 in FIG. 3), data to be displayed on the external device (e.g., the external device 230 in FIG. 2) will be briefly described below. The processor may establish the communication connection with the wearable device (e.g., the wearable devices 210 in FIG. 2) and the external server (e.g., the external server 220 in FIG. 2). The processor may acquire the input data by using the wearable device, the camera (e.g., the camera 340 in FIG. 3), and the microphone (e.g., the microphone 350 in FIG. 3) and create the computation data on the basis of the input data. On the basis of at least one of the input data and the computation data, the processor may modify some of the data to be displayed on the external device or determine at least some of the data that are not to be displayed. The processor may determine to modify the data and to display the data on the external device, and then transmit the input data to the external server. An operation of the embodiment of the disclosure will be described specifically with reference to FIG. 4.

Referring to FIG. 4, the processor may output a user interface 410, which displays content 400, image data 418, input data 412 and 414, computation data, and data of the user of the external device, to the display (e.g., the display 320 in FIG. 3). According to various embodiments of the disclosure, the processor may output the currently playing content 400 in one region of the display. For example, in case that the user works out while watching images, the content 400 (e.g., a workout content) may be displayed in one region of the display.

According to various embodiments of the disclosure, the processor may output the user interface 410 in a region that does not overlap (or partially overlaps) the content 400. According to various embodiments of the disclosure, the processor may acquire the image data 418 from the camera and output the image data 418 to the display. The image data 418 may be a screen captured by the camera and include the user of the electronic device (e.g., the electronic device 200 in FIG. 2 and the electronic device 300 in FIG. 3). According to the embodiment of the disclosure, the processor may additionally output the input data 412 and 414, the computation data, and a phrase indicating the current privacy mode in the region in which the image data 418 are outputted. The processor may display (the input data 412 and 414) the input data, which are acquired from the wearable device, together with one side of the image data 418. For example, the current heart rate, the calorie consumption, the workout speed, the posture accuracy, the workout performance points, and the current rankings may be displayed. The processor may output the graphic object, which indicates the current privacy mode, on the screen. For example, in the current image privacy situation, the processor may modify at least one region of the image data 418 and display a phrase (e.g., AR emoji: On), which indicates the image privacy situation, at one side of the image data 418. The processor may indicate the current situation, which is related to whether the voice privacy is made, on an icon 416 displayed at one side of the image data 418. For example, after the voice privacy situation is determined, the processor may mute the icon 416 and determine not to output the voice data from the external device.

According to various embodiments of the disclosure, the processor may output at least some of the data of the user of the external device in one region of the user interface 410. The processor may output separate screens corresponding to the respective external devices. For example, in case that a first external user, a second external user, a third external user, and a fourth external user work out together, the processor may output a screen, which displays the data of the first external user, the second external user, the third external user, and the fourth external user, at a lower end of the image data 418 of the electronic device. The respective external user's input data, the computation data, and the image data 418 may be outputted to the screens that display the respective external user's data. According to the embodiment of the disclosure, depending on whether each of the external users is in the privacy situation, some of the data may not be outputted, and at least one of the voice data and the image data 418 may not be outputted.

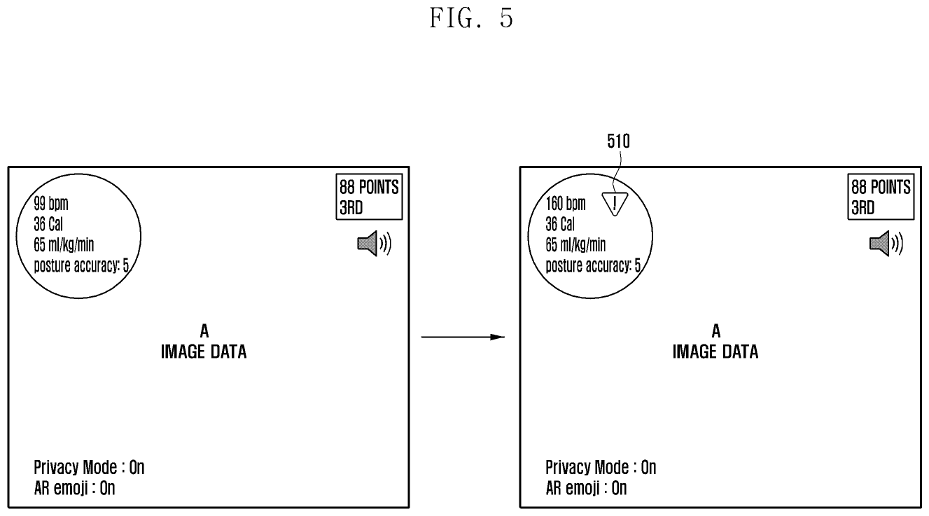

FIG. 5 is a view illustrating a state in which an electronic device provides a notification to a user when input data satisfy a designated condition according to an embodiment of the disclosure.

Referring to FIG. 5, the processor (e.g., the processor 310 in FIG. 3) may provide a notification to the user in case that the preliminary privacy situation occurs. The processor may output at least some of the input data and the computation data to the display (e.g., the display 320 in FIG. 3). According to the embodiment of the disclosure, the processor may provide a notification related to the items of the data on which the preliminary privacy situation occurs. For example, in case that the user's heart rate reaches a preliminary privacy situation reference value, the processor may add a graphic object 510, which indicates that the user's heart rate reaches a designated reference value, at one side of the heart rate data. According to another embodiment of the disclosure, the processor may change the color of the phrase, which indicates the heart rate data, and output the phrase. Thereafter, when the heart rate data are reduced to be less than the preliminary privacy situation reference value again, the processor may restore the color to the original color or remove the graphic object 510 created to indicate that the data reach the designated reference value.

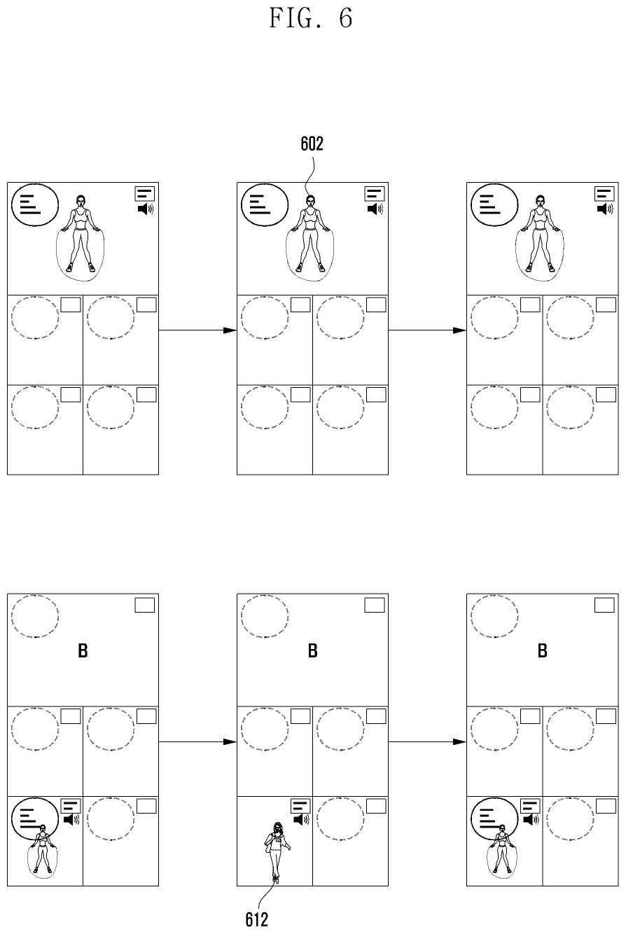

FIG. 6 is a view illustrating an embodiment in which an electronic device modifies the image data according to an embodiment of the disclosure.

Referring to FIG. 6, hereinafter, the embodiment in which the processor (e.g., the processor 310 in FIG. 3) modifies the image data on the basis of the input data and the computation data will be described briefly. The processor may output input data, computation data, image data 602, and voice data before the privacy situation occurs. In a situation in which the user falls while working out, the processor may determine that the image privacy situation and the data privacy situation occur on the basis of changes in workout speed and body height. In addition, on the basis of the acquired heart rate or speed in the gravitational direction acquired from the wearable device, the processor may determine that the data privacy situation occurs. The processor may modify at least some of the image data 602 and transmit the data, which include the modified image data, to the external server (e.g., the external server 220 in FIG. 2). In response to the determination of the occurrence of the data privacy situation, the processor may determine not to display at least some (e.g., protection data) of the input data and the computation data on the external device. In case that the user subsequently gets back up and resumes the workout, this situation is not the privacy situation. Therefore, the processor may transmit the image data 602 in its original form to the external server and determine to display all the input data and the computation data on the external device.

According to various embodiments of the disclosure, the processor may output the input data, the computation data, the image data 602, and the voice data. The processor may output the user interface, which includes the input data, the computation data, and the image data 602, on the display (e.g., the display 320 in FIG. 3) and output the voice data. The processor may transmit the data to the external server and determine the data so that all the data are normally outputted from the external device (e.g., the external device 230 in FIG. 2). The external device may output the input data and the image data that are transmitted by the processor.

According to various embodiments of the disclosure, the processor may determine the privacy situation on the basis of the input data and the computation data. For example, in case that the user falls during the workout, the processor may detect the amount of change in workout speed and body height and determine that the user falls. For example, in case that the user's workout speed decreases by 80% or more for 3 seconds and the amount of change in body height is 50% for 3 seconds, the processor may determine that the user falls, and the processor may determine that the image privacy situation and the data privacy situation occur.

According to various embodiments of the disclosure, the processor may modify at least some of the image data and transmit the image data to the external server. The processor may modify at least one region of the image data in response to the determination of the image privacy situation. For example, the processor may output the graphic object in the region in which the fallen user is outputted. The processor may transmit modified image data 612 to the external server. The external device may receive the modified image data 612 from the external server, and the external device may output the modified image data 612. In contrast, the image data 602 in its original form may be outputted in an intact manner on the display of the electronic device (e.g., the electronic device 200 in FIG. 2 and the electronic device 300 in FIG. 3).

According to various embodiments of the disclosure, the processor may determine not to display at least some of the input data and the computation data on the external device. In response to the determination of the occurrence of the data privacy situation, the processor may determine not to display at least some of the data on the external device. For example, in the situation in which the processor determines that the user falls during the workout, the processor may determine not to display the protection data, such as the user's posture accuracy and heart rate, on the external device.

According to various embodiments of the disclosure, when the processor determines that the user resumes the workout on the basis of the input data, the processor may transmit the image data to the external server without modifying the image data, and the processor may determine to display all the data on the external device. For example, in case that the workout speed returns to the workout speed made before the image privacy situation occurs or the amount of change in body height is not detected, the processor may determine that this situation is not the image privacy situation and the data privacy situation, and the processor may not modify the data.

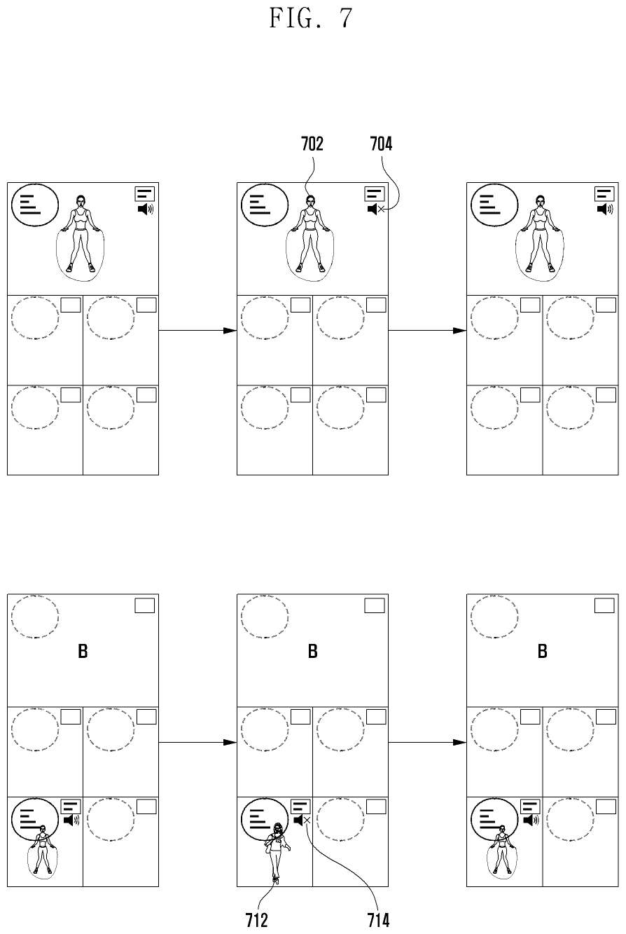

FIG. 7 is a view illustrating an embodiment in which an electronic device modifies image data and voice data according to an embodiment of the disclosure.

Referring to FIG. 7, hereinafter, the embodiment will be briefly described in which on the basis of the input data and the computation data, the processor (e.g., the processor 310 in FIG. 3) modifies the image data and determines not to output the voice data from the external device (e.g., the external device 230 in FIG. 2). The processor may output input data, computation data, image data 702, and voice data before the privacy situation occurs. In a situation in which the user has a phone call during the workout, the processor may determine that the image privacy situation and the voice privacy situation occur on the basis of the change in workout speed and heart rate. The processor may modify at least some of the image data and transmit the data, which include the modified image data, to the external server (e.g., the external server 220 in FIG. 2). The processor may determine not to output the voice data from the external device. In case that the user ends the phone call and resumes the workout, this situation is not the privacy situation. Therefore, the processor may transmit the image data and the voice data in its original form to the external server.

According to various embodiments of the disclosure, the processor may output the input data, the computation data, the image data 702, and the voice data. The processor may output the user interface, which includes the input data, the computation data, and the image data 702, on the display (e.g., the display 320 in FIG. 3) and output the voice data. The processor may additionally output an icon, which indicates that the voice data are normally outputted, on the display. The processor may transmit the data to the external server and determine the data so that all the data are normally outputted from the external device. The external device may output the input data and the image data that are transmitted by the processor.

According to various embodiments of the disclosure, the processor may determine the image privacy situation and the voice privacy situation on the basis of the input data and the computation data. For example, in case that the user has a phone call during the workout, the processor may detect the change in workout speed and heart rate, determine that the user stops working out, and determine that the user is on the phone with reference to the image data and the voice data. For example, in case that the user's workout speed decreases by 80% or more for 3 seconds and the heart rate decreases by 30% or more for 3 seconds, the processor may determine that the user is on the phone and determine that the voice privacy situation and the image privacy situation occur.

According to various embodiments of the disclosure, the processor may modify at least some of the image data and transmit the image data to the external server. The processor may modify at least one region of the image data in response to the determination of the image privacy situation. For example, the processor may output the graphic object in the region in which the user, who is on the phone, is outputted. The processor may transmit modified image data 712 to the external server. The external device may receive the modified image data 712 from the external server, and the external device may output the modified image data 712. In contrast, the image data 702 in its original form may be outputted in an intact manner on the display of the electronic device (e.g., the electronic device 200 in FIG. 2 and the electronic device 300 in FIG. 3).

According to various embodiments of the disclosure, the processor may determine not to output the voice data from the external device and transmit the data to the external server. The processor may determine not to output the voice data from the external device so that the external users cannot listen to phone calls.

According to various embodiments of the disclosure, the processor may output an icon 704, which indicates the voice privacy situation, on the display. For example, the processor may output the icon 704 and indicates that the current voice is not outputted from the external device. A mute icon 714 may also be displayed on the screen of the external device on which the user's data are displayed.

According to various embodiments of the disclosure, when the processor determines that the user resumes the workout on the basis of the input data, the processor may transmit the image data to the external server without modifying the image data, and the processor may determine to output the voice data from the external device. For example, in case that the workout speed and the heart rate return back to the workout speed and the heart rate made before the image privacy situation occurs, the processor may determine that this situation is not the image privacy situation and the voice privacy situation.

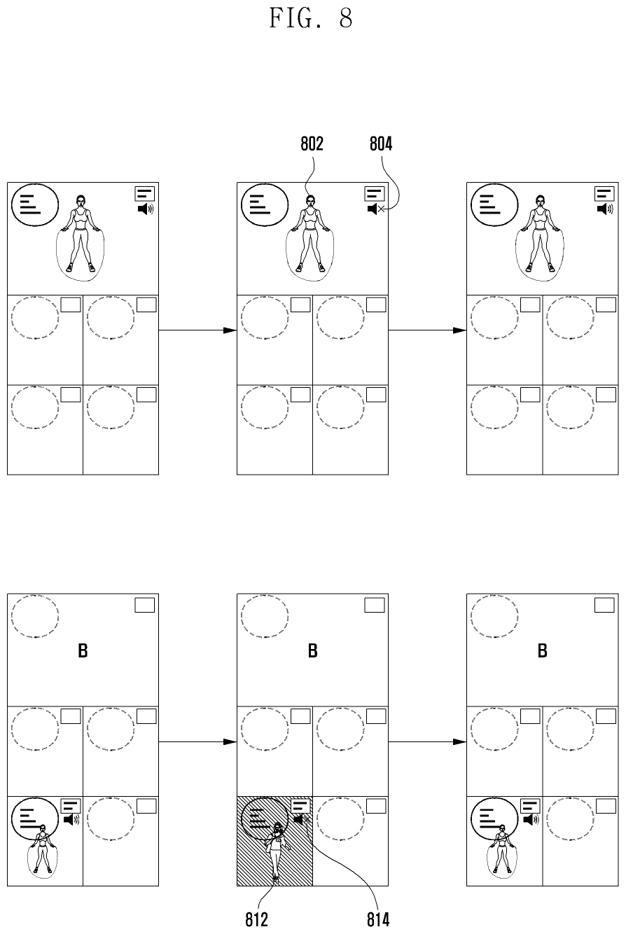

FIG. 8 is a view illustrating an embodiment in which an electronic device modifies image data and voice data according to an embodiment of the disclosure.

Referring to FIG. 8, the processor (e.g., the processor 310 in FIG. 3) may variously modify an image data 802. The embodiment in which the processor detects the image privacy situation, modifies the image data 802, and transmits the image data to the external device (e.g., the external device 230 in FIG. 2) is identical to the embodiment described above with reference to FIGS. 3 and 7. When the processor modifies the image data 802, the processor may recognize a background and the user's face and body included in the image data 802. In case that the image privacy situation is determined, the processor may determine whether to modify a region including any one of the background and the user's face and body depending on the current circumstances. For example, in case that the user disappears out of the screen, the processor may modify the background 812. The processor may modify the image data by adding the graphic object to the background 812. In case that the user disappears out of the screen, it is not necessary to transmit the voice data to the external device, and thus the processor may determine this situation as the voice privacy situation. The processor may display a mute icon 804 on the display (e.g., the display 320 in FIG. 3) and display a mute icon 814 on the external device without transmitting the voice data.

According to another embodiment of the disclosure, in case that a second user appears on the background, e.g., an image when a first user captures images while working out, the processor may determine that the image privacy situation occurs, and the processor may modify a region of the image data in which the second user is positioned. Alternatively, in case that the second user's voice is recognized instead of the first user's voice, the processor may determine that the voice privacy situation occurs. In response to the determination of the occurrence of the voice privacy situation, the processor may display the mute icon 804 and may not transmit the voice data to the external device. Thereafter, in case that the second user disappears from the image data and the second user's voice is not received, the processor may end the voice privacy situation and the image privacy situation and transmit the image data and the voice data in the original forms to the external server without modifying the image data and the voice data.

The electronic device according to various embodiments may include the microphone, the camera, the communication module, and the processor operatively connected to the microphone, the camera, and the communication module, in which the processor may be configured to receive the input data from the microphone, the camera, and/or at least one wearable device, modify at least some of the input data or determine at least some of the input data as data that are not to be transmitted from the external server to the external device on the basis of whether at least some of the input data satisfy a designated condition, and transmit the input data to the external server.

According to various embodiments of the disclosure, the one or more computer programs further include computer-executable instructions that, when executed by the one or more processor, may cause the electronic device to provide a notification to the data in case that at least some of the input data satisfy a designated criterion.

According to various embodiments of the disclosure, the input data may include at least one of the voice data acquired from the microphone, the image data acquired from the camera, and the body data acquired from the wearable device.

According to various embodiments of the disclosure, the one or more computer programs further include computer-executable instructions that, when executed by the one or more processor, may cause the electronic device to create the computation data on the basis of at least some of the input data and modify at least some of the computation data or determine at least some of the computation data as the data, which are not to be transmitted from the external server to the external device, on the basis of whether at least some of the computation data satisfy the designated condition.

According to various embodiments of the disclosure, the computation data may include at least one of the posture accuracy, the workout performance points, and the rankings.

According to various embodiments of the disclosure, the one or more computer programs further include computer-executable instructions that, when executed by the one or more processor, may cause the electronic device to modify at least one region of the image data at least on the basis of the image data.

According to various embodiments of the disclosure, the one or more computer programs further include computer-executable instructions that, when executed by the one or more processor, may cause the electronic device to modify a region of the image data that includes at least one of the user's face, the user's full body, and the background.

According to various embodiments of the disclosure, the one or more computer programs further include computer-executable instructions that, when executed by the one or more processor, may cause the electronic device to determine the voice data as the data, which are not to be transmitted from the external server to the external device at least on the basis of the voice data.

According to various embodiments of the disclosure, the one or more computer programs further include computer-executable instructions that, when executed by the one or more processor, may cause the electronic device to determine at least some of the input data and the computation data as the protection data and determine the protection data as the data, which are not to be transmitted from the external server to the external device in response to the configuration in which the input data and the computation data satisfy the designated condition.

According to various embodiments of the disclosure, the electronic device may further include the display, and the processor may be configured to output at least some of the input data and computation data to the display.

According to various embodiments of the disclosure, the one or more computer programs further include computer-executable instructions that, when executed by the one or more processor, may cause the electronic device to receive the data related to at least one external device from the external server and output the graphic object, which corresponds to each of the external devices, to the display.

According to various embodiments of the disclosure, the one or more computer programs further include computer-executable instructions that, when executed by the one or more processor, may cause the electronic device to identify whether first data satisfy a first condition and second data satisfy a second condition, and modify at least some of the input data, or determine at least some of the input data or the computation data as the data that are not to be transmitted from the external server to the external device.

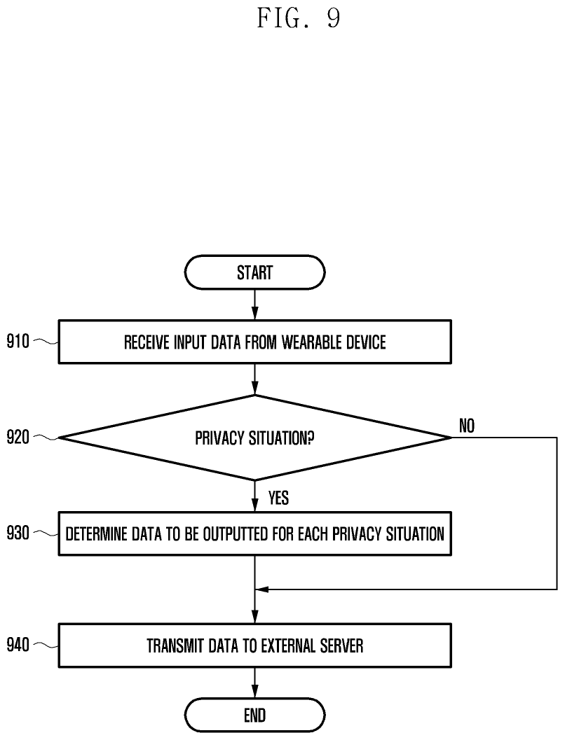

FIG. 9 is a flowchart of an output data determination method of an electronic device according to an embodiment of the disclosure.

Referring to FIG. 9, the method may be performed by the electronic devices (e.g., the electronic device 101 in FIG. 1 and the electronic device 200 in FIG. 2) described with reference to FIGS. 1 to 8. Hereinafter, the description of the above-mentioned technical feature will be omitted.

According to various embodiments of the disclosure, at operation 910, the electronic device may receive the input data from the wearable device (e.g., the wearable devices 210 in FIG. 2). The electronic device may establish the communication connection with the wearable device and the external server (e.g., the external server 220 in FIG. 2). The electronic device may establish the communication connection with at least one wearable device. The input data may be data acquired from the wearable device communicatively connected to the electronic device or the data acquired directly by the electronic device by using the microphone (e.g., the microphone 350 in FIG. 3) and the camera (e.g., the camera 340 in FIG. 3).

According to various embodiments of the disclosure, the electronic device may directly collect the input data without using the wearable device communicatively connected to the electronic device. According to the embodiment of the disclosure, the electronic device may acquire the voice data by using the microphone. For example, the electronic device may acquire the voice data around the electronic device by activating the microphone. According to another embodiment of the disclosure, the electronic device may acquire the image data by using the camera.

According to various embodiments of the disclosure, the electronic device may create computation data on the basis of the input data. For example, the electronic device may determine that the rankings with the other users are determined on the basis of the posture accuracy, and the electronic device may determine the rankings of the users by comparing the posture accuracy of the user of the electronic device and the posture accuracy of the other users.

According to various embodiments of the disclosure, the electronic device may determine data, which are to be displayed on the external device (e.g., the external device 230 in FIG. 2), on the basis of the input data and/or the computation data. According to the embodiment of the disclosure, when the input data and/or computation data satisfy a designated condition, the electronic device may determine not to display the input data and/or computation data on the external device. For example, when the input data are larger than designated values, the electronic device may determine no to display the input data on the external device. The privacy situation may include the data privacy situation, the voice privacy situation, and the image privacy situation. The electronic device may determine whether the situation corresponds to at least one of the data privacy situation, the voice privacy situation, and the image privacy situation on the basis of the input data and the computation data, and the electronic device may modify the data or determine not to display the data on the external device.

According to various embodiments of the disclosure, at operation 920, the electronic device may determine whether the situation is the privacy situation. The electronic device may determine at least some of the input data and the computation data, which need not be exposed to the public, as the data privacy situation. According to the embodiment of the disclosure, the electronic device may determine at least some of the data as protection data.

According to various embodiments of the disclosure, in case that the electronic device detects an inappropriate word or receives a sound at a decibel level above a predetermined value, the electronic device may determine this situation as the voice privacy situation. The electronic device may learn the user's voice in advance. In case that a voice, which is not the user's voice in the received voice data, is recognized, the electronic device may determine not to output the voice data from the external device.

According to various embodiments of the disclosure, in case that the user disappears from a screen of the external device or falls, the electronic device may determine this situation as the image privacy situation. In case that a result of analyzing the image data indicates that the corresponding image needs to be prevented from being outputted from the external device, the electronic device may determine this situation as the image privacy situation. For example, in case that the user trips or falls while working out while watching images played on the electronic device, the electronic device may detect that the user has fallen from the image data and determine this situation as the image privacy situation.

According to various embodiments of the disclosure, at operation 930, the electronic device may determine the data to be outputted for each privacy situation. According to various embodiments of the disclosure, in case that the data privacy situation is determined, the electronic device may determine not to display the protection data on the external device. For example, in case that the heart rate and the calorie consumption are determined as the protection data, the electronic device may determine not to display the heart rate and the calorie consumption on the external device and transfer information, which indicates that the heart rate, the calorie consumption data and the heart rate, or the calorie consumption data need not be displayed, to the external server. According to the embodiment of the disclosure, the external server may not transmit the data, which are determined as the protection data, to the external device. According to an embodiment of the disclosure, the external server may transmit the data, which are determined as the protection data, to the external device but instruct the external device not to display the protection data.

According to various embodiments of the disclosure, when the voice privacy situation is determined, the electronic device may determine not to output (or determine to mute) the received voice data from the external device. The external device may not output the voice data received from the electronic device. After the voice privacy situation is ended, the external device may normally output the voice data again.

According to various embodiments of the disclosure, when the image privacy situation is determined, the electronic device may modify at least one region of the image data. The electronic device may modify the image data by outputting the graphic object (e.g., an AR emoji) in at least one region of the image data. The electronic device may transmit the image data, to which the graphic object is added, to the external server so that another user cannot recognize, from the external device, the scene in which the user falls. According to another embodiment of the disclosure, the electronic device may determine not to output the image data from the external device. For example, in case that the region in which the graphic object needs to be outputted from the image data has a designated value or more, the electronic device may not output the graphic object and determine not to output the image data from the external device.

According to various embodiments of the disclosure, the electronic device may determine that two or more types of privacy situations have occurred simultaneously. For example, the electronic device may determine that the image privacy situation and the voice privacy situation have occurred simultaneously.

According to the embodiment of the disclosure, in case that a plurality of items in the input data satisfies the designated condition, the electronic device may determine this situation as the privacy situation. For example, in case that another person's body other than the user's body is recognized from the image data and the muscle activation decreases by 30% or more for 3 second, this situation may be determined as the privacy situation. According to the embodiment of the disclosure, in case that the amount of change in body height is 50% or more for 3 second and the workout speed decreases by 80% or more for 3 seconds, this situation may be determined as the privacy situation.

According to various embodiments of the disclosure, at operation 940, the electronic device may transmit the data to the external server. The electronic device may establish communication connection with the external server and transmit the input data. For example, the data transmitted by the electronic device may include voice data and image data, and at least some of the transmitted data may be determined not to be outputted from the external device. For example, in the data privacy situation, the protection data may be determined not to be outputted to the external device. In the voice privacy situation, the voice data may be determined not to be outputted to the external device. In the image privacy situation, at least one region of the image data may be modified, or the image data may be determined not to be outputted.

According to various embodiments of the disclosure, the electronic device may output a user interface, which is configured on the basis of the acquired input data and the acquired computation data, to the display (e.g., the display 320 in FIG. 3). For example, the user interface of the electronic device may include input data, computation data, and image data. The user interface may display the user's data of at least one external device. For example, the user interface may include a first user's image data and input data, a second user's image data and input data, and a third user's image data and input data. According to the embodiment of the disclosure, the user interface may further include a graphic object that indicates whether the external device outputs the user's voice data. For example, in case that the second user is in the voice privacy situation, an icon, which indicates the voice is muted and not outputted, may be additionally displayed in a region in which the second user's data are outputted.

According to the embodiment of the disclosure, the electronic device may output various comparison data on the basis of the data of the user of the electronic device and the user of the external device. For example, in case that the users work out while watching workout images, the electronic device may calculate rankings on the basis of workout performance and output the rankings to the display. The electronic device may calculate the workout performance on the basis of the input data of the user of the electronic device and the user of the external device and determine the rankings of the calculated workout performance of the plurality of users. The electronic device may display the determined rankings in the region in which the user's data are displayed.

According to the embodiment of the disclosure, even in the privacy situation, the electronic device may output all the input data, the computation data, the image data, and the voice data. For example, in the image privacy situation, the electronic device may determine to modify at least one region of the image data of the external device or determine not to output the image data from the external device. However, the electronic device may output the image data in its original form. For example, in the data privacy situation, the electronic device may determine not to output the protection data from the external device, but the electronic device may output the protection data to the display.

According to various embodiments of the disclosure, the electronic device may detect a situation in which the privacy situation is highly likely to occur, and the electronic device may provide a notification to the user. The preliminary privacy situation may mean a situation that does not satisfy a criterion for the occurrence of the privacy situation but is relatively highly likely to occur. According to the embodiment of the disclosure, the criterion for which the electronic device determines whether this situation is the preliminary privacy situation may have a value smaller than a reference value by which the electronic device determines this situation as the privacy situation. For example, the electronic device may determine a situation, in which the user's heart rate is increased by 70% in comparison with the average heart rate at ordinary times, as the privacy situation, and the electronic device may determine a situation, in which the heart rate is increased by 50% in comparison with the average heart rate at ordinary times, as the preliminary privacy situation.

According to various embodiments of the disclosure, the electronic device may modify at least some of the image data in the preliminary privacy situation. Because the privacy situation is highly likely to occur in the preliminary privacy situation, the electronic device may modify at least some of the image data from the preliminary privacy situation in order to quickly cope with the privacy situation. For example, in case that the current user's workout speed satisfies a preliminary privacy reference value, the electronic device may modify at least one region of the image data so that at least one region of the image data is semi-transparent. When the user's workout speed is high, the user may fall, and the privacy situation may occur. Therefore, the electronic device may modify at least some of the image data from the preliminary privacy situation in order to quickly respond to the privacy situation. According to another embodiment of the disclosure, in a voice preliminary privacy situation, the electronic device may reduce a volume of the voice data outputted from the external device. In a voice privacy situation, the electronic device determines not to output the voice data from the external device. However, in the preliminary privacy situation, the electronic device may determine to quickly respond to the occurrence of the privacy situation by reducing the volume of the voice data outputted from the external device.

According to various embodiments of the disclosure, the electronic device may provide a notification to the user in the preliminary privacy situation. According to the embodiment of the disclosure, the electronic device may provide the user with a notification related to a data item that reaches a preliminary privacy situation determination reference value. For example, in case that the user's workout speed satisfies the preliminary privacy situation determination reference value, the electronic device may display a portion, which indicates the workout speed item, in a color different from the colors of the other portions on the user interface. For example, the notification may be provided to the user in a state in which the other data are displayed in a first color, and only the workout speed is displayed in a second color. According to another embodiment of the disclosure, the electronic device may provide a voice guide that notifies the user of the preliminary privacy situation.

The embodiments of the disclosure disclosed in the specification and illustrated in the drawings are provided as particular examples for easily explaining the technical contents the disclosure and helping understand the disclosure, but not intended to limit the scope of the disclosure. It is obvious to those skilled in the art to which the disclosure pertains that other modified embodiments may be carried out based on the technical spirit of the disclosure in addition to the embodiments disclosed herein.

An output data determination method of an external device according to various embodiments may include an operation of establishing communication connection with at least one wearable device and an external server by using a communication module, an operation of receiving input data from a microphone, a camera, or the at least one wearable device, an operation of modifying at least some of the input data or determining at least some of the input data as data, which are not to be transmitted from the external server to the external device, on the basis of whether at least some of the input data satisfy a designated condition, and an operation of transmitting the input data to the external server.

According to various embodiments of the disclosure, the output data determination method may include an operation of providing a notification related to the data when at least one of the input data satisfy a designated criterion.

According to various embodiments of the disclosure, the input data may include at least one of the voice data acquired from the microphone, the image data acquired from the camera, and the body data acquired from the wearable device.

According to various embodiments of the disclosure, the operation of modifying at least some of the input data or determining at least some of the input data as the data that are not to be transmitted from the external server to the external device may include an operation of creating computation data on the basis of at least some of the input data, and an operation of modifying at least some of the computation data or determining at least some of the computation data as the data that are not to be transmitted from the external server to the external device on the basis of whether at least some of the computation data satisfy the designated condition.

According to various embodiments of the disclosure, the operation of modifying at least some of the input data may include an operation of modifying at least one region of the image data at least on the basis of the image data.

According to various embodiments of the disclosure, the operation of modifying at least some of the input data may include an operation of modifying a region of the image data that includes at least one of the user's face, the user's full body, and the background.

According to various embodiments of the disclosure, the operation of determining at least some of the input data as the data that are not to be transmitted from the external server to the external device may include an operation of determining the voice data as the data that are not to be transmitted from the external server to the external device at least on the basis of the voice data.

According to various embodiments of the disclosure, the operation of determining at least some of the input data as the data that are not to be transmitted from the external server to the external device may include an operation of determining at least some of the input data and the computation data as the protection data, and an operation of determining the protection data as the data that are not to be transmitted from the external server to the external device in response to the input data and the computation data satisfying the designated condition.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a microphone;
a camera;
communication circuitry;
memory storing one or more computer programs; and
one or more processors communicatively coupled to the microphone, the camera, the communication circuitry, and the memory,
wherein the one or more computer programs include computer-executable instructions that, when executed by the one or more processors, cause the electronic device to:
receive input data from the microphone, the camera, and/or at least one wearable device,
modify at least some of the input data or determine at least some of the input data as data that are not to be transmitted from an external server to an external device based on whether at least some of the input data satisfy a designated condition, and
transmit the input data to the external server.

2. The electronic device of claim 1, wherein the one or more computer programs further include computer-executable instructions that, when executed by the one or more processors, cause the electronic device to provide a notification related to the data when at least one of the input data satisfies a designated criterion.

3. The electronic device of claim 1, wherein the input data comprise at least one of voice data acquired from the microphone, image data acquired from the camera, or body data acquired from the wearable device.

4. The electronic device of claim 3, wherein the one or more computer programs further include computer-executable instructions that, when executed by the one or more processors, cause the electronic device to:
create computation data based on at least some of the input data, and
modify at least some of the computation data or determine at least some of the computation data as data that are not to be transmitted from the external server to the external device based on whether at least some of the computation data satisfies the designated condition.

5. The electronic device of claim 4, wherein the computation data comprise at least one of posture accuracy, a workout performance point, or a ranking.

6. The electronic device of claim 4, wherein the one or more computer programs further include computer-executable instructions that, when executed by the one or more processors, cause the electronic device to modify at least one region of the image data at least based on the image data.

7. The electronic device of claim 6, wherein the one or more computer programs further include computer-executable instructions that, when executed by the one or more processors, cause the electronic device to modify a region of the image data that includes at least one of a user's face, a user's full body, or a background.

8. The electronic device of claim 4, wherein the one or more computer programs further include computer-executable instructions that, when executed by the one or more processors, cause the electronic device to determine the voice data as data that are not to be transmitted from the external server to the external device at least based on the voice data.

9. The electronic device of claim 4, wherein the one or more computer programs further include computer-executable instructions that, when executed by the one or more processors, cause the electronic device to:
determine at least some of the input data and the computation data as protection data, and
determine the protection data as data that are not to be transmitted from the external server to the external device in response to the input data and the computation data satisfying the designated condition.

10. The electronic device of claim 4,
wherein the electronic device further comprises a display, and
wherein the one or more computer programs further include computer-executable instructions that, when executed by the one or more processors, cause the electronic device to output at least some of the input data and computation data to the display.

11. The electronic device of claim 10, wherein the one or more computer programs further include computer-executable instructions that, when executed by the one or more processors, cause the electronic device to:
receive data related to at least one external device from the external server, and
output a graphic object corresponding to the external device to the display.

12. The electronic device of claim 4, wherein the one or more computer programs further include computer-executable instructions that, when executed by the one or more processors, cause the electronic device to:
identify whether first data satisfy a first condition and second data satisfy a second condition, and
modify at least some of the input data or determine at least some of the input data or the computation data as data that are not to be transmitted from the external server to the external device.

13. An output data determination method of an external device, the method comprising:
establishing communication connection between at least one wearable device and an external server by using communication circuitry;
receiving input data from a microphone, a camera, or the at least one wearable device;
modifying at least some of the input data or determining at least some of the input data as data that are not to be transmitted from the external server to the external device based on whether at least some of the input data satisfies a designated condition; and
transmitting the input data to the external server.

14. The method of claim 13, further comprising:
providing a notification related to the data when at least one of the input data satisfies a designated criterion.

15. The method of claim 13, wherein the input data comprise at least one of voice data acquired from the microphone, image data acquired from the camera, or body data acquired from the wearable device.

16. The method of claim 15, further comprising:
creating computation data based on at least some of the input data; and
modifying at least some of the computation data or determine at least some of the computation data as data that are not to be transmitted from the external server to the external device based on whether at least some of the computation data satisfies the designated condition.

17. The method of claim 16, wherein the computation data comprise at least one of posture accuracy, a workout performance point, or a ranking.

18. The method of claim 16, further comprising:
modifying at least one region of the image data at least based on the image data.

19. One or more non-transitory computer-readable storage media storing computer-executable instructions that, when executed by one or more processors of an external device, cause the external device to perform operations, the operations comprising:
establishing communication connection between at least one wearable device and an external server by using communication circuitry;
receiving input data from a microphone, a camera, or the at least one wearable device;
modifying at least some of the input data or determining at least some of the input data as data that are not to be transmitted from the external server to the external device based on whether at least some of the input data satisfies a designated condition; and
transmitting the input data to the external server.

20. The one or more non-transitory computer-readable storage media of claim 19, the operations further comprising:
providing a notification related to the data when at least one of the input data satisfies a designated criterion.
